(19) United States
(12) Patent Application Publication
(10) Pub. No.: US 2011/0019079 A1
(43) Pub. Date: Jan. 27, 2011

(54) IMAGING APPARATUS

(75) Inventor: JUN SAIKI, Osaka (JP)

Correspondence Address: PANASONIC PATENT CENTER, 1130 CONNECTICUT AVENUE NW, SUITE 1100, WASHINGTON, DC, 20036, US

(73) Assignee: PANASONIC CORPORAION, Osaka (JP)

(21) Appl. No.: 12/843,244

(22) Filed: Jul. 26, 2010

(30) Foreign Application Priority Data
Jul. 27, 2009 (JP) 2009-174064

(51) Int. Cl. H04N 5/225; F16M 13/02

(52) U.S. Cl. 348/375; 248/224.7; 348/E05.026

(57) ABSTRACT

An imaging apparatus having a tripod socket to which a tripod is attachable. The tripod socket is fixed to the imaging apparatus in mutually-perpendicular two directions.

### BACKGROUND

1. Technical Field

The technical field relates to an imaging apparatus capable of recording a still image and a moving image, and more particularly to an imaging apparatus that can be fixed to a tripod.

2. Related Art

JP2004-77880A is known as a prior art document relating to an imaging apparatus having a tripod socket. A camera disclosed in JP2004-77880A includes a body frame incorporating various kinds of mechanisms for imaging, a tripod attachment member having a screw hole for fixing a tripod, and a pair of front/back covers covering the body frame from front and back. Further, the camera includes an engaging hole formed on the tripod attachment member, an engaging claw formed on the body frame, and a position limiting member formed on each of the inner sides of the front/back covers. The tripod attachment member is arranged on the bottom surface of the body frame. The engaging hole is engaged with the engaging claw so that the tripod attachment member is temporarily fixed to a position close to a fixing position and the front/back covers are attached to the body frame. Thus, the position limiting member sandwiches the tripod attachment member and limits the position of the tripod attachment member to the fixing position.

In the camera disclosed in JP2004-77880A, the number of parts and steps are reduced while sufficient strength is ensured for fixing the tripod attachment member to the body frame, so that production cost can be reduced. Further, according to the camera disclosed in JP2004-77880A, the position of the screw hole can be located reliably and easily when the tripod attachment member is fixed, thus achieving efficient assembly work.

Recently, imaging apparatuses are made compact, and thus the arrangement position of a tripod socket is limited, and there may be a case where the tripod socket must be arranged on an end portion of the bottom surface of an imaging apparatus. This is because, a base of a lens barrel may interfere with a screw hole of the tripod socket in the imaging apparatus if the tripod socket is arranged in a central part of the bottom surface of the imaging apparatus, since the lens barrel is located in a central part of the front surface of the imaging apparatus.

However, if the tripod socket is arranged at the end portion of the bottom surface of the imaging apparatus, the tripod supports the imaging apparatus at the end part of the bottom surface of the imaging apparatus, so that a rotational moment around the tripod socket is exerted by the gravity on the imaging apparatus. Therefore, it is necessary to increase fixing strength of the tripod socket.

To solve the above problem, an imaging apparatus is provided that can improve fixing strength of a tripod socket arranged on the bottom of the imaging apparatus.

### SUMMARY

An imaging apparatus has a tripod socket to which a tripod is attachable. The tripod socket is fixed to the imaging apparatus in mutually-perpendicular two directions.

The imaging apparatus may further include a front case including a lateral surface portion wrapping around a lateral surface of a front side of the imaging apparatus, and a back case including a lateral surface portion wrapping around a lateral surface of a back side of the imaging apparatus. The tripod socket may be fixed to at least the lateral surface portion of the front case and the lateral surface portion of the back case.

The imaging apparatus may further include a front case including a bottom surface portion wrapping around a bottom surface of a front side of the imaging apparatus, and a back case including a bottom surface portion wrapping around a bottom surface of a back side of the imaging apparatus. The tripod socket may be fixed to at least the bottom surface portion of the front case and the bottom surface portion of the back case.

According to the above aspect, the tripod socket is fixed to the imaging apparatus in mutually-perpendicular two directions, and thus an imaging apparatus with improved fixing strength of the tripod socket arranged at the end portion of the bottom surface can be provided.

Further, the tripod socket can be fixed to the lateral surface portion of the front case and the lateral surface portion of the back case. In such a case, the front case and the back case can be coupled with each other with further improved fixing strength of the tripod socket. Likewise, the tripod socket is fixed to the bottom surface portion of the front case and the bottom surface portion of the back case. Also in such a case, the front case and the back case can be coupled with each other with improved fixing strength of the tripod socket.

### BRIEF DESCRIPTION OF DRAWINGS

FIGS. 1A to 1C are external views illustrating a digital camera according to an embodiment.

FIG. 2 is a view illustrating the digital camera according to the embodiment which is fixed to a tripod.

FIG. 3 is a perspective view illustrating the digital camera according to the embodiment which is seen from the bottom surface side.

FIG. 4 is a partial cross sectional view illustrating attachment of a tripod socket.

FIG. 5 is an exploded perspective view illustrating the digital camera according to the embodiment which is seen from the bottom surface side.

FIG. 6 is a perspective view illustrating the tripod socket.

FIG. 7 is an exploded perspective view illustrating the digital camera according to the embodiment.

### DETAILED DESCRIPTION OF PREFERRED EMBODIMENT

The digital camera according to a preferred embodiment will be explained with reference to the drawings.

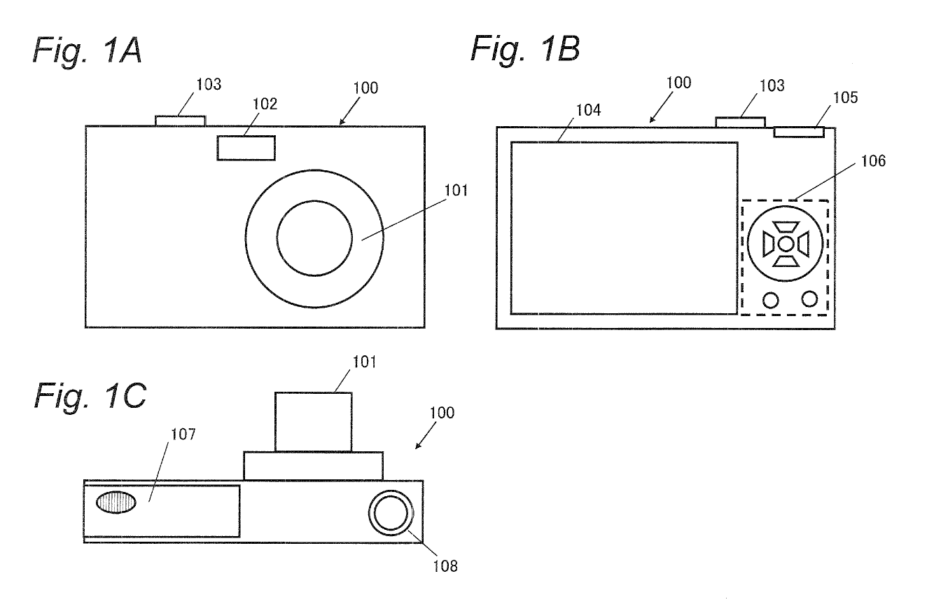

FIGS. 1A to 1C are external views illustrating a digital camera according to an embodiment of the present invention. FIG. 1A is a front view, FIG. 1B is a back view, and FIG. 1C is a bottom view.

An imaging optical system 101 and a flash 102 are arranged on the front of the digital camera 100 (see FIG. 1A). The imaging optical system 101 forms a subject image on an imaging device (not shown) in the digital camera 100. The flash 102 emits a flash light to compensate the lack of the amount of light for shooting when a picture is taken in a dark place. A shutter button 103 is arranged on the upper surface of the digital camera 100. When the shutter button 103 is pressed, image data based on the subject image formed on the imaging device is recorded to a recording medium such as a memory card (not shown).

A liquid crystal display monitor 104, a mode dial 105, and various operation buttons 106 are arranged on the back of the digital camera 100 (see FIG. 1B). The liquid crystal display monitor 104 displays an image based on the subject image formed on the imaging device. Therefore, a user can decide a composition for shooting while seeing the image displayed on the liquid crystal display monitor 104. Further, the liquid crystal display monitor 104 can display an image based on image data recorded in the recording medium.

An operation mode of the digital camera 100 can be selected by operating the mode dial 105. The operation modes of the digital camera 100 include a recording mode and a playback mode. The recording mode is an operation mode which can record image data based on the subject image formed on the imaging device to the recording medium such as a memory card by pressing down the shutter button 103. The recording mode is further divided into a full automatic recording mode, a program recording mode, a shutter speed priority recording mode, an aperture priority recording mode, and a distinct scene recording mode. The playback mode is an operation mode which can display an image based on image data recorded in the recording medium on the liquid crystal display monitor 104. By operation of the various operation buttons 106, further detailed settings can be made in the recording mode and the playback mode. Specifically, in the recording mode, settings of exposure correction, white balance adjustment, light emission of the flash 102, and the like can be made. In the playback mode, for example, an image displayed on the liquid crystal monitor 104 can be enlarged and reduced, the number of images to be displayed on the liquid crystal display monitor 104 at a time can be set, and the image data recorded in the recording medium such as a memory card can be retrieved.

On the bottom surface of the digital camera 100 (see FIG. 1C), a storage section 107 and a tripod socket 108 are arranged. The storage section 107 can be opened and closed, and store a battery (not shown) and the recording medium such as a memory card therein. The tripod socket 108 is a member with which a tripod is attached to the digital camera 100. The inside of the tripod socket 108 is threaded, so that the digital camera 100 can be fixed to a tripod with the tripod socket 108.

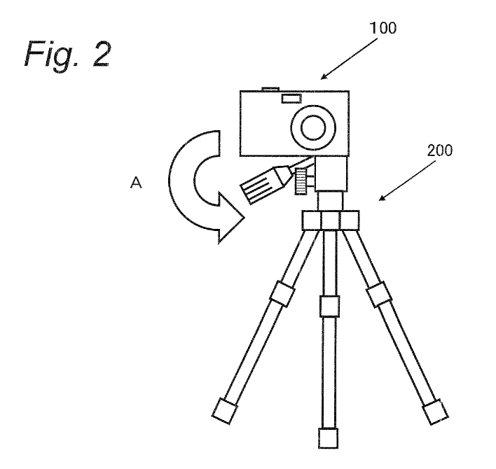

FIG. 2 is a view illustrating the digital camera according to the embodiment with the digital camera fixed to a tripod.

When a picture is taken with the digital camera 100 fixed to a tripod 200, deterioration of the quality of image data due to hand movement, which can not be avoided in taking a picture with the camera held by hands, can be avoided. Taking a picture with the tripod 200 is effective for a night view shooting which needs long exposure time and is affected by hand shake, super-telescopic shooting which is more likely to be affected by hand shake, and so on.

Since the tripod 100 is fixed to an end portion of the bottom surface of the digital camera 100, a rotational moment (arrow A) about the tripod socket is exerted on the digital camera 100 by the gravity.

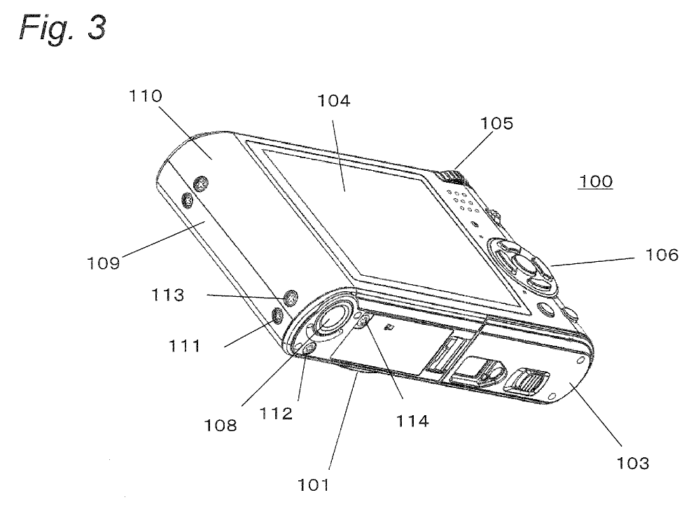

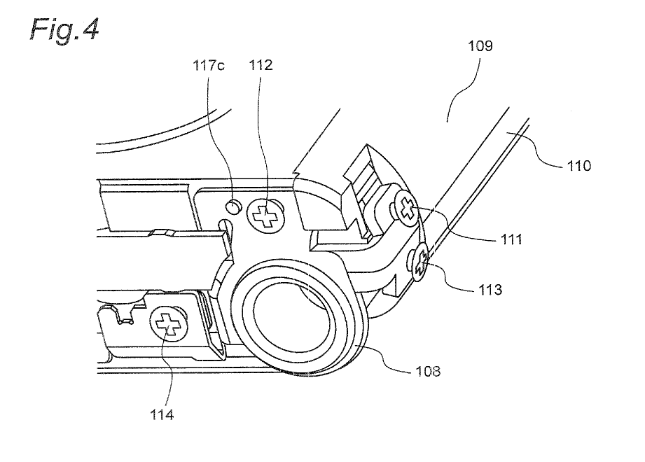

FIG. 3 is a perspective view illustrating the digital camera according to the embodiment when the digital camera is seen from the bottom surface side. FIG. 4 is a view (partial cross sectional view) illustrating attachment of the tripod socket 108.

As shown in FIG. 3, the digital camera 100 is structured such that a front case 109 and a back case 110 enclose the internal members. As shown in FIG. 3 and FIG. 4, the tripod socket 108 is fixed with a screw 111 to a lateral surface on the front side of the front case 109, and is further fixed with the screw 112 to a bottom surface of the front side of the front case 109. The tripod socket 108 is fixed. with a screw 113 to a lateral surface on the back side of the back case 110, and is further fixed with the screw 114 to a bottom surface of the back side of the back case 110.

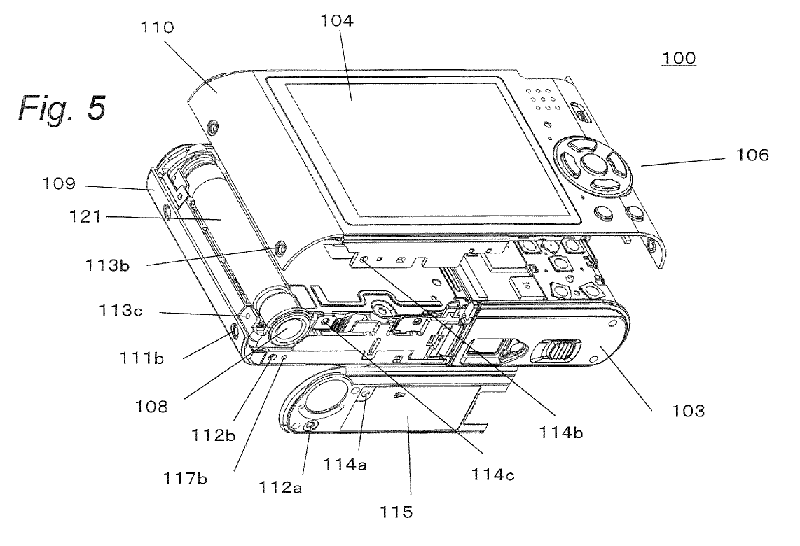

FIG. 5 is an exploded perspective view illustrating the digital camera according to the embodiment with the digital camera seen from the bottom surface side. FIG. 5 shows a state of the digital camera from which the back case 110 and a bottom cover 115 are removed. A hole 117b into which a boss 117c arranged on the tripod socket 108 is inserted is formed on the front case 109.

As shown in FIG. 3 and FIG. 4, the tripod socket 108 is fixed to the digital camera 100 with the four screws 111, 112, 113, and 114. The screw 111 fixes the front case 109 and the tripod socket 108, with a screw hole 111b arranged on the lateral surface of the front side of the front case 109 and a screw hole 111c (which cannot be seen in FIG. 5) arranged on the tripod socket 108. The screw 112 fixes the bottom cover 115, and the front case 109, and the tripod socket 108, through a screw hole 112a arranged on the bottom cover 115, a screw hole 112b arranged on the bottom surface of the front side of the front case 109, and a screw hole 112c (which cannot be seen in FIG. 5) arranged on the tripod socket 108. The screw 113 fixes the back case 110 and the tripod socket 108, with a screw hole 113b arranged on the lateral surface of the back side of the back case 110 and a screw hole 113c arranged on the tripod socket 108. The screw 114 fixes the bottom cover 115, the front case 109, and the tripod socket 108, with a screw hole 114a arranged on the bottom cover 115, a screw hole 114b arranged on the bottom surface of the back side of the back case 110, and a screw hole 114c arranged on the tripod socket 108.

In other words, the four screws 111, 112, 113, and 114 are used as follows. The screw 111 passes into the screw hole 111b of the front case 109 and the screw hole 111c of the tripod socket 108 to fix the front case 109 and the tripod socket 108. The screw 112 passes into the screw hole 112a of the bottom cover 115, the screw hole 112b of the front case 109, and the screw hole 112c of the tripod socket 108, to fix the bottom cover 115, the front case 109, and the tripod socket 108. The screw 113 passes into the screw hole 113b of the back case 110 and the screw hole 113c of the tripod socket 108 to fix the back case 110 and the tripod socket 108. The screw 114 passes into the screw hole 114a of the bottom cover 115, the screw hole 114b of the back case 110, and the screw hole 114c of the tripod socket 108 to fix the bottom cover 115, the back case 110, and the tripod socket 108.

As described above, in the present embodiment, the tripod socket 108 is fixed to the digital camera 100 in mutually-perpendicular two directions (in a length direction and a height direction of the imaging apparatus), thereby improving fixing strength of the tripod socket 108. Furthermore, since the tripod socket 108 is fixed to the lateral surface of the front side of the front case 109 and the lateral surface of the back side of the back case 110, it is possible to couple the front case 109 with the back case 110 while improving the fixing strength of the tripod socket 108. Similarly, since the tripod socket 108 is fixed to the bottom surface of the front side of the front case 109 and the bottom surface of the back side of the back case 110, it is possible to couple the front case 109 with the back case 110 while improving the fixing strength of the tripod socket 108.

It should be noted that it is not necessary to arrange the bottom cover 115. The external housing of the digital camera 100 may be constituted by the front case 109 and the back case 110 in the same manner as the lateral surface of the digital camera 100.

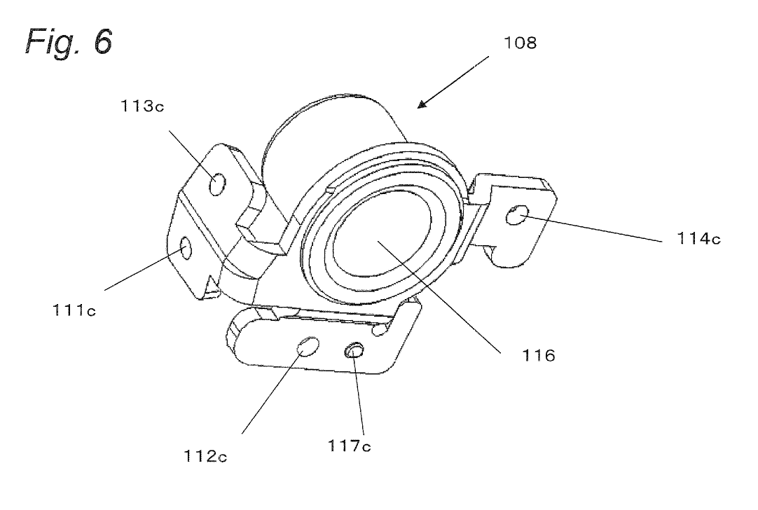

FIG. 6 is a perspective view illustrating the tripod socket 108. The tripod socket 108 is preferably made of metal, but may also be made of resin. A screw hole 116 is formed in a central portion of the tripod socket 108 to fix the tripod. In a plane in parallel with the screw hole 116, the screw hole 111c is arranged to fix the tripod socket 108 to the lateral surface of the front side of the front case 109, and the screw hole 113c is arranged to fix the tripod socket 108 to the lateral surface of the back side of the back case 110. In a plane perpendicular to the screw hole 116, the screw hole 112c is arranged to fix the tripod socket 108 to the bottom surface of the front side of the front case 109, and the screw hole 114c is arranged to fix the tripod socket 108 to the bottom surface of the back side of the back case 110. When the tripod socket 108 is attached to the front case 109, the boss 117c entering into the hole 117b formed. on the front case 109 allows the tripod socket 108 to be positioned.

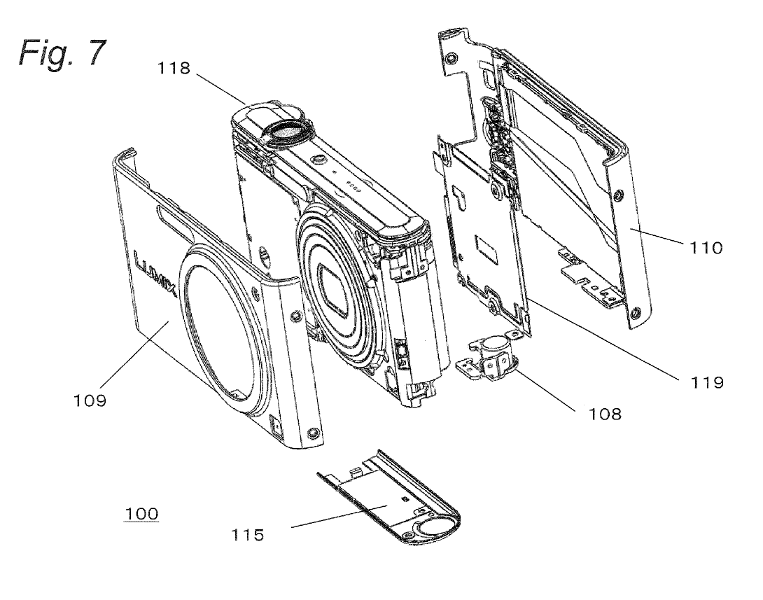

FIG. 7 is an exploded perspective view illustrating the digital camera according to the embodiment. The digital camera 100 is structured such that the front case 109 and the back case 110 enclose internal members 118. The internal members 118 include an imaging optical system, a flash, a power supply circuit, a signal processing circuit, and the like. Since the liquid crystal display monitor 104 is arranged on the back case 110, a protective plate 119 is arranged on the back of the liquid crystal display monitor 104 to protect it.

In the digital camera according to the present embodiment, the tripod socket 108 is fixed to the lateral surface of the front side of the front case 109 and the lateral surface of the back side of the back case 110. Similarly, the tripod socket 108 is fixed. to the bottom surface of the front side of the front case 109 and the bottom surface of the back side of the back case 110. However, the fixing method is not limited thereto. For example, the following variations are conceivable.

Firstly, it can be considered that the front case wraps around the entire lateral surface of the digital camera so that the lateral surface of the digital camera is formed by only the front case. Similarly, the back case wraps around the entire lateral surface of the digital camera, so that the lateral surface of the digital. camera is formed by only the back case. In such cases, the tripod socket may be fixed with one screw to either one of the front case and the back case at the lateral surface of the digital camera. When the tripod socket is fixed with a screw to either one of the front case and the back case, the front case and the back case may be fixed by swaging.

In another example, the external housing of the digital camera is constituted by the front case, the back case, and the side case. In this case, the tripod socket may also be fixed with one screw to the side case at the lateral surface of the digital camera.

In still another example, both of the front case and the back case wrap around the lateral surfaces of the digital camera to overlap with each other and form the lateral surfaces of the digital camera. In this case, the tripod socket may be fixed with one screw to the front case and the back case at the lateral surface of the digital camera. Three examples of forming of the lateral surface of the digital camera have been hereinabove explained. It should be noted that the above examples are also applicable to the bottom surface of the digital camera.

Generally, a digital camera includes a storage capacitor which is a device for supplying power for driving a flash. The storage capacitor is usually arranged at the inner peripheral portion of the digital camera. In such a case, arrangement of the tripod socket on the end portion of the bottom of the camera body and in the space below the storage capacitor is more useful.

In FIG. 5, a cylindrical device 121 which is arranged coaxially to the tripod socket 108 is a storage capacitor. Most of storage capacitors are approximately cylindrical and a diameter of the storage capacitor is almost same as that of the tripod socket 108. When the length of the storage capacitor 121 is shorter than the height of the camera body, a dead space is made below the storage capacitor. Accordingly, arrangement of the tripod socket 108 in the dead space allows a space in the camera body to be used effectively while achieving strong fixation of the tripod socket 108.

In the above examples, the tripod socket 108 is arranged at the end portion of the bottom of the camera body. However, the position at which the tripod socket 108 is arranged is not limited thereto. For example, instead of arrangement of the tripod socket 108 in the end portion of the bottom of the camera body, the tripod socket 108 may be arranged at the center portion of the bottom of the camera body. In this case, the tripod socket 108 is fixed at two directions: a bottom surface and a front surface or two directions of a bottom surface and a back surface. The tripod socket 108 may be fixed at three directions of a bottom surface, a front surface, and a back surface. This allows the tripod socket 108 to be fixed more strongly.

As described above, in the present embodiment, the tripod socket 108 is fixed to the camera body in at least two mutually-perpendicular directions (on the sides of the lateral surface and the bottom surface). Therefore, a digital camera 100 with improved fixing strength. of the tripod socket arranged at the end portion of the bottom surface can be provided.

Further, by fixing the tripod socket 108 to the lateral surface portion of the front case 109 and the lateral surface portion of the back case 110, the fixing strength of the tripod socket 108 can be further improved, and the front case 109 and the back case 110 can be coupled with each other. Similarly, by fixing the tripod socket 108 to the bottom portion of the front case 109 and the bottom surface portion of the back case 110, the fixing strength of the tripod socket 108 can be improved, and the front case 109 and the back case 110 can be coupled with each other.

### INDUSTRIAL APPLICABILITY

The embodiment can provide an imaging apparatus having further improved fixing strength of a tripod socket. Therefore, the embodiment is useful for an imaging apparatus having a tripod socket such as a video camera and a digital camera.

What is claimed is:

1. An imaging apparatus comprising a tripod socket to which a tripod is attachable, wherein
the tripod socket is fixed to the imaging apparatus in mutually-perpendicular two directions.

2. The imaging apparatus according to claim 1 further comprising:
a front case including a lateral surface portion wrapping around a lateral surface of a front side of the imaging apparatus; and
a back case including a lateral surface portion wrapping around a lateral surface of a back side of the imaging apparatus, wherein
the tripod socket is fixed to at least the lateral surface portion of the front case and the lateral surface portion of the back case.

3. The imaging apparatus according to claim 2, wherein the front case further includes a bottom surface portion wrapping around a bottom surface of a front side of the imaging apparatus, and the back case further includes a bottom surface portion wrapping around a bottom surface of a back side of the imaging apparatus, and wherein
the tripod socket is further fixed to the bottom surface portion of the front case and the bottom surface portion of the back case.

4. The imaging apparatus according to claim 1 further comprising:
a front case including a bottom surface portion wrapping around a bottom surface of a front side of the imaging apparatus; and
a back case including a bottom surface portion wrapping around a bottom surface of a back side of the imaging apparatus, wherein
the tripod socket is fixed to at least the bottom surface portion of the front case and the bottom surface portion of the back case.

5. The imaging apparatus according to claim 1, wherein the tripod socket is arranged at an end portion of a bottom surface of the imaging apparatus.

6. The imaging apparatus according to claim 1, wherein the tripod socket is arranged in a space below a storage capacitor.

7. The imaging apparatus according to claim 1, wherein the mutually-perpendicular directions include a length direction and a height direction of the imaging apparatus.
